(19) United States
(12) Patent Application Publication
(10) Pub. No.: US 2025/0200254 A1
(43) Pub. Date: Jun. 19, 2025

(54) CHARACTERISTIC PREDICTION SYSTEM

(71) Applicant: DENSO CORPORATION, Kariya-city (JP)

(72) Inventor: Naoki TEGA, Kariya-city (JP)

(21) Appl. No.: 19/071,063

(22) Filed: Mar. 5, 2025

Related U.S. Application Data
(63) Continuation of application No. PCT/JP2023/030505, filed on Aug. 24, 2023.

(30) Foreign Application Priority Data
Sep. 9, 2022 (JP) 2022-143961

(51) Int. Cl. G06F 30/27; G06F 113/18

(52) U.S. Cl. CPC G06F 30/27; G06F 2113/18

(57) ABSTRACT

A characteristic prediction system acquires an electrical characteristic of a semiconductor device measured by a measurement instrument, and predicts an out-of-range characteristic, which is the electrical characteristic of the semiconductor device beyond a measurable range of the measurement instrument, from at least the electrical characteristic acquired and using a prediction model stored in a memory unit.

### CROSS REFERENCE TO RELATED APPLICATIONS

The present application is a continuation application of International Patent Application No. PCT/JP2023/030505 filed on Aug. 24, 2023, which designated the U.S. and claims the benefit of priority from Japanese Patent Application No. 2022-143961 filed on Sep. 9, 2022. The entire disclosures of all of the above applications are incorporated herein by reference.

### TECHNICAL FIELD

The present disclosure relates to a characteristic prediction system.

### BACKGROUND

In a manufacturing method of semiconductor devices, it has been known to perform a burn-in necessity determination process of determining whether or not a burn-in-test is necessary for each semiconductor chip based on a measurement data in a probe test process. In the manufacturing method of the semiconductor devices, based on the result of the burn-in necessity determination process, packages are divided into a first lot for packages made of semiconductor chips that have been determined to require the burn-in-test and a second lot for packages made of semiconductor chips that have been determined not to require the burn-in-test. In the manufacturing method, the burn-in test is performed only for the packages of the first lot.

### SUMMARY

The present disclosure describes a characteristic prediction system. A characteristic prediction system according to an aspect acquires an electrical characteristic of a semiconductor device measured by a measurement instrument, and predicts an out-of-range characteristic, which is the electrical characteristic of the semiconductor device beyond a measurable range of the measurement instrument, from at least the electrical characteristic acquired and using a prediction model stored in a memory unit.

### BRIEF DESCRIPTION OF THE DRAWINGS

Features and advantages of the present disclosure will become more apparent from the following detailed description made with reference to the accompanying drawings, in which:

FIG. 1 is a block diagram showing a schematic configuration of a characteristic prediction system;

FIG. 2 is a flowchart showing a processing operation of the characteristic prediction system;

FIG. 3 is a plan view showing a semiconductor wafer;

FIG. 4 is a diagram showing prediction results in the characteristic prediction system;

FIG. 5 is a diagram showing measurement data measured by a measurement instrument;

FIG. 6 is a diagram showing non-measurement data;

FIG. 7 is a diagram showing training data;

FIG. 8 is a diagram showing prediction data;

FIG. 9 is a diagram showing the relationship between the measurement data and the prediction data;

FIG. 10 is a flowchart showing a processing operation of a characteristic prediction system according to a modified example; and

FIG. 11 is a diagram showing classification results.

### DETAILED DESCRIPTION

Incidentally, semiconductor devices are sometimes required to operate in high temperature environments or with large currents. For this reason, the semiconductor devices are required to have guaranteed specifications regarding electrical characteristics in the high temperature environments or when the large current flows. However, in mass production of the semiconductor devices, it may be difficult to measure electrical characteristics using a measurement instrument under such conditions of the high temperature environments or the large currents.

The present disclosure provides a characteristic prediction system capable of predicting an electrical characteristic that is difficult to be measured by using a measurement instrument.

According to an aspect of the present disclosure, a characteristic prediction system includes: a measurement device configured to acquire an electrical characteristic of a semiconductor device measured by a measurement instrument; a storage device in which a prediction model for predicting an out-of-range characteristic of the electrical characteristic beyond a measurable range of the measurement instrument, is stored; and a prediction device configured to predict the out-of-range characteristic from at least the electrical characteristic acquired by the measurement device using the prediction model.

The characteristic prediction system according to the aspect described above includes the storage device that has the prediction model for predicting the out-of-range characteristic stored therein. The characteristic prediction system predicts the out-of-range characteristic, using the prediction model, from at least the electrical characteristic acquired by the measurement device. Therefore, the characteristic prediction system can predict the out-of-range characteristic, which are difficult to be measured by the measurement instrument.

An embodiment of the present disclosure will be described with reference to the drawings. A characteristic prediction system 100 is a system that predicts electrical characteristics of multiple semiconductor chips C1 to Cn formed on a semiconductor wafer 200. In particular, the characteristic prediction system 100 is a system that predicts electrical characteristics that are difficult to measure with a measurement instrument 30, in the mass-production of the semiconductor chips C1 to Cn. In the drawings, the characteristic prediction system 100 is denoted by PDIT, the semiconductor wafer 200 is denoted by SEM, and the measurement instrument 30 is denoted by MES. Also, a measurement computer 20 is denoted by 1COM, a prediction computer 10 is denoted by 2COM, a processor is denoted by PCS, and a memory device is denoted by MEM. Each of the semiconductor chips C1 to Cn corresponds to a semiconductor device.

<Semiconductor Wafer>

As shown in FIG. 3, a semiconductor wafer 200 has multiple semiconductor chips C1 to Cn formed thereon. More specifically, the semiconductor wafer 200 includes a substrate mainly made of silicon (Si), silicon carbide (SiC), or the like, and components of the semiconductor chips C1 to Cn are formed on the substrate by semiconductor processes. In other words, the semiconductor wafer 200 includes multiple regions that will become the multiple semiconductor chips C1 to Cn. That is, the semiconductor wafer 200 is divided into the multiple semiconductor chips C1 to Cn by dicing. The semiconductor chips C1 to Cn are, for example, metal oxide semiconductor field effect transistors (MOSFETs) or insulated gate bipolar transistors (IGBTs). The components of the semiconductor chips include, for example, a gate electrode, a drain electrode, a source electrode, a drift layer, a buffer layer, and a trench structure. “n” is a natural number of 2 or more.

### Configuration

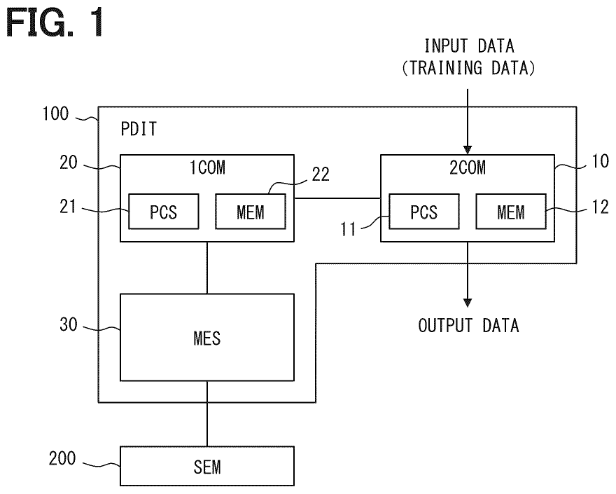

First, the configuration of the characteristic prediction system 100 will be described with reference to FIG. 1. The characteristic prediction system 100 includes a measurement computer 20, a prediction computer 10, and a measurement instrument 30.

The measurement computer 20 includes a processor 21 such as a central processing unit (CPU), a memory device 22 including a volatile memory and a non-volatile memory, and the like. The measurement computer 20 is configured to be communicable with the measurement instrument 30 and the prediction computer 10.

The processor 21 executes a program stored in the memory device 22. The processor 21 executes various controls by executing the program and carrying out arithmetic processing. For example, the processor 21 executes the control of the measurement instrument 30. The processor 21 instructs the measurement instrument 30 to measure the electrical characteristics of each of the semiconductor chips C1 to Cn. The processor 21 acquires the electrical characteristics, as measurement results, measured by the measurement instrument 30. The processor 21 then inputs the electrical characteristics into the prediction computer 10. The processor 21 corresponds to a measurement device. The processor 21 can also be referred to as a measurement processor. The memory device 22 stores programs executed by the processor 21, electrical characteristics, and the like.

In response to the instruction from the processor 21, the measurement instrument 30 measures the electrical characteristics of each of the semiconductor chips C1 to Cn. The measurement instrument 30 measures the electrical characteristics within the measurable range (condition) of the measurement instrument 30. The measurement instrument 30 inputs measurement data including the measured electrical characteristics into the prediction computer 10.

The measurable range includes a small current and a low temperature environment. The small current means an electric current having a quantity that can be measured by the measurement instrument 30. The low temperature means a temperature that can be measured by the measurement instrument 30. In this case, the measurement instrument 30 is not a device that can perform measurements at the time of a large current, such as 1000 A or higher, or in a high temperature environment, such as 200 degrees Celsius (° C.). The electrical characteristics measured by the measurement instrument 30 may be, for example, regarded as electrical characteristics at the time of a small current, electrical characteristics in a low temperature environment, or electrical characteristics at the time of a low current in a low temperature environment.

As shown in FIG. 5, the measurement instrument 30 measures, for each of the semiconductor chips C1 to Cn, an on-voltage (Von), a threshold voltage (Vth), a breakdown voltage (Vbr), a forward voltage (Vf), and a switching loss (Eon, Eoff, Err) as the electrical characteristics. In addition, the measurement instrument 30 may measure a saturation current, a capacitance (Crss, Ciss, Coss), a voltage change rate (dv/dt), a current change rate (di/dt), a recovery current, a surge voltage, a gate total charge (Qg) and the like.

“Eon” represents a turn-on loss that occurs at the time of turn-on. “Eoff” represents a turn-off loss that occurs at the time of turn-off. “Err” represents a recovery loss.

“Crss” represents a feedback capacitance equivalent to a gate-to-drain parasitic capacitance. “Ciss” represents the sum of a gate-source parasitic capacitance and a gate-drain parasitic capacitance and is an input capacitance related to a gate charging and discharging speed. “Coss” represents the sum of a drain-source parasitic capacitance and a gate-drain parasitic capacitance and is an output capacitance related to a source-drain switching speed.

“dv/dt” represents the voltage change between the drain and the source per unit time, which occurs during a switching transition. “di/dt” represents the current change of the recovery current flowing through a body diode of the MOSFET.

The measurement instrument 30 may measure, as the electrical characteristics, a short circuit resistance, a voltage change resistance, a recovery resistance, an avalanche resistance, and the like. Further, the measurement instrument 30 may perform a gate screening test, a breakdown voltage screening test, a reverse bias test, a high temperature gate bias test and the like, as the electrical characteristics. The measurement instrument 30 may be any instrument that measures at least one of the above-mentioned electrical characteristics.

The prediction computer 10 includes a processor 11 such as a CPU, a memory device 12 including a volatile memory and a non-volatile memory, and the like. The prediction computer 10 is configured to be communicable with the measurement computer 20. The prediction computer 10 is configured to be able to receive input data and to output output data. The input data includes the measurement data output from the measurement computer 20 and training data for generating a prediction model. The output data includes predicted data predicted by the prediction computer 10.

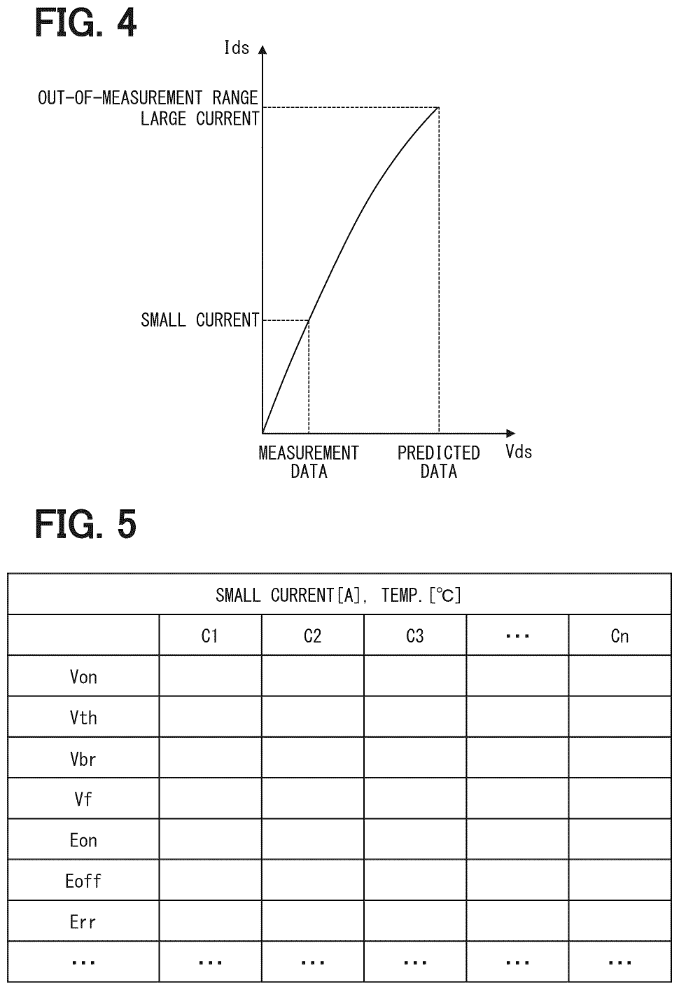

The processor 11 executes a program stored in the memory device 12. The processor 11 executes various controls by executing the program and carrying out arithmetic processing. For example, the processor 11 generates a prediction model through machine learning using the training data. Further, the processor 11 predicts the predicted data at least from the measurement data using the prediction model, as shown in FIG. 4. The processor 11 corresponds to a prediction device. The processor 11 can also be referred to as a prediction processor. The memory device 12 stores programs executed by the processor 11, prediction models, predicted data, and the like.

The prediction computer 10 may predict the predicted data from the measurement data and non-measurement data related to each of the semiconductor chips C1 to Cn, the non-measurement data being different from the electrical characteristics. The non-measurement data corresponds to non-electrical information.

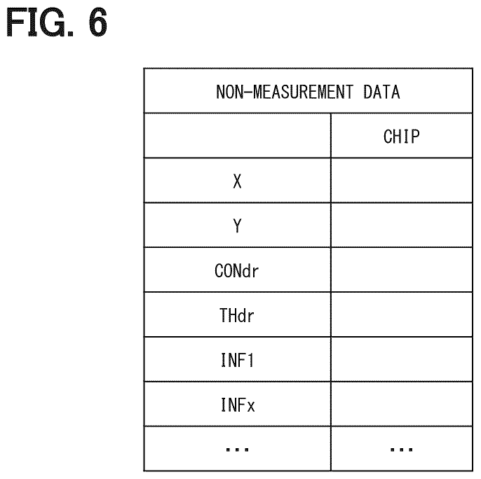

An example of the non-measurement data is shown in FIG. 6. The non-measurement data includes at least one of coordinate information of each of the semiconductor chips C1 to Cn in the semiconductor wafer 200, component information of each of the semiconductor chips C1 to Cn in the semiconductor wafer 200, and manufacturing process information of the semiconductor device. The coordinate information includes information on the X coordinate and the Y coordinate of each of the semiconductor chips C1 to Cn. The component information includes information on the concentration of a drift layer and thickness of the drift layer. The manufacturing process information includes information indicating the dimensions of the components of each of the semiconductor chips C1 to Cn measured in manufacturing processes, such as an in-process inspection 1 and an in-process inspection x. In FIG. 6, “X” represents the X coordinate, “Y” represents the Y-coordinate, “CONdr” represents the concentration of the drift layer, and “THdr” represents the thickness of the drift layer. Also, “INF1” represents the in-process inspection 1 and “INFx” represents the in-process inspection x. Examples of the dimensions of the components include the dimensions of a voltage sustaining layer, the dimensions of a trench in a trench MOS, and the thickness of a gate insulating film. These dimensions of the components can be measured, for example, by a critical dimension-scanning electron microscope (SEM).

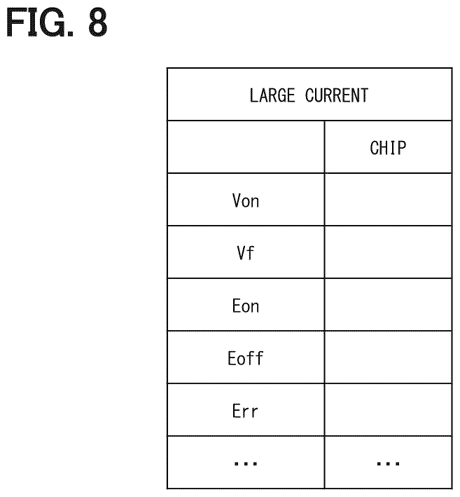

An example of the predicted data is shown in FIG. 8. The predicted data includes the electrical characteristics of each of the semiconductor chips C1 to Cn exceeding the measurable range of the measurement instrument 30. The predicted data includes predicted values of the electrical characteristics of each of the semiconductor chips C1 to Cn when a large current over 1000 A is applied in a high temperature environment over 200° C., for example. In addition, the predicted data may include predicted values of the electrical characteristics of each of the semiconductor chips C1 to Cn in a high temperature environment, such as over 200° C., or predicted values of the electrical characteristics of each of the semiconductor chips C1 to Cn when a large current, such as over 1000 A, is applied. Therefore, the predicted data can be regarded as the electrical characteristics that are difficult to measure with the measurement instrument 30. The predicted data corresponds to the out-of-range characteristics. The predicted data may be data including, for example, electrical characteristics at the time of a large current, electrical characteristics in a high temperature environment, or electrical characteristics at the time of a large current in a high temperature environment.

The prediction computer 10 predicts, as the predicted date, for example, values in a high temperature environment and at a large current of the electrical characteristics measured by the measurement instrument 30. Further, the prediction computer 10 may predict, as the predicted data, the results of the gate screening test, the breakdown voltage screening test, the reverse bias test, the high temperature gate bias test, and the like in a high temperature environment and at the time of a large current. Furthermore, the prediction computer 10 may predict, as the predicted data, a durability performance and a market failure rate. The prediction computer 10 may be any computer that can predict at least one of multiple electrical characteristics as the predicted data.

The prediction model is for predicting the electrical characteristics of each of the semiconductor chips C1 to Cn. In the present embodiment, a prediction model that predicts predicted data including electrical characteristics of each of the semiconductor chips C1 to Cn exceeding the measurable range of the measurement instrument 30, among the electrical characteristics of each of the semiconductor chips C1 to Cn. The prediction model can also be considered as a mechanism or algorithm for predicting the predicted data from the measurement data as the input data. Therefore, it can be regarded that the processor 11 predicts, using the prediction model, the electrical characteristics of each of the semiconductor chips C1 to Cn under conditions where it is difficult to perform the measurement by the measurement instrument 30.

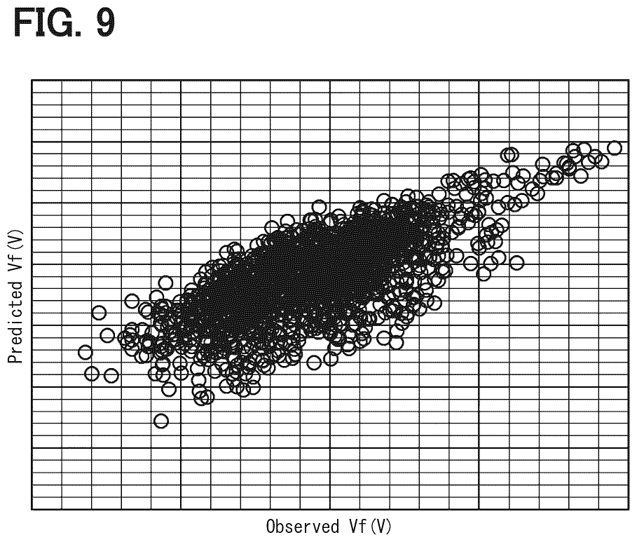

The prediction model is a machine learning model generated in a well-known method. The machine learning includes deep learning and simple perceptron. In the case of deep learning, it may be based on a simple perceptron or a multi-layer perceptron. In the case where the training data is an imbalanced dataset, over-sampling or under-sampling process may be included. FIG. 9 shows an example of the forward voltage predicted (anticipated) by the multi-layer perceptron. In FIG. 9, the horizontal axis represents measurement data (actually measured values), and the vertical axis represents predicted data. The machine learning model can also be referred to as a trained model.

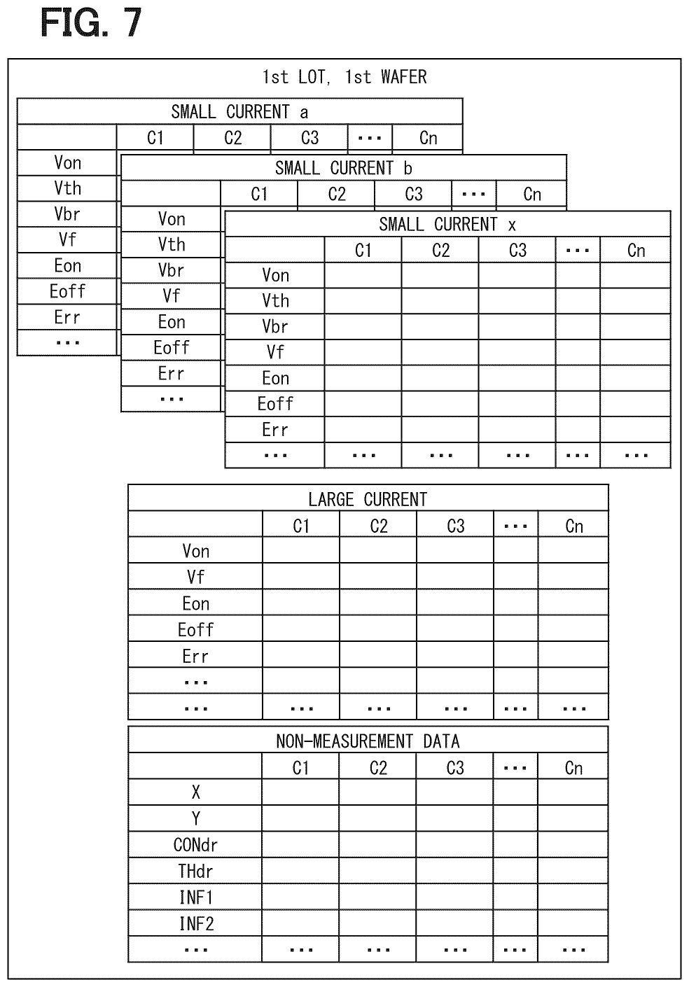

As shown in FIG. 7, the training data includes measurement data that includes the measurement results at the times of the small currents, the electrical characteristics in high temperature environments or at the time of a large current, non-measurement data, and the like. FIG. 7 shows the training data for a first wafer of a first lot only. However, the training data is not limited to the illustrated example. The training data may include measurement data and non-measurement data for multiple wafers composed of multiple lots. The electrical characteristics at the time of the large current in the training data are, for example, electrical characteristics measured at the time of the large current for some of the multiple semiconductor chips C1 to Cn. The electrical characteristics in the high temperature environment in the training data are, for example, electrical characteristics measured in the high temperature environment for some of the multiple semiconductor chips C1 to Cn.

### Processing Operation

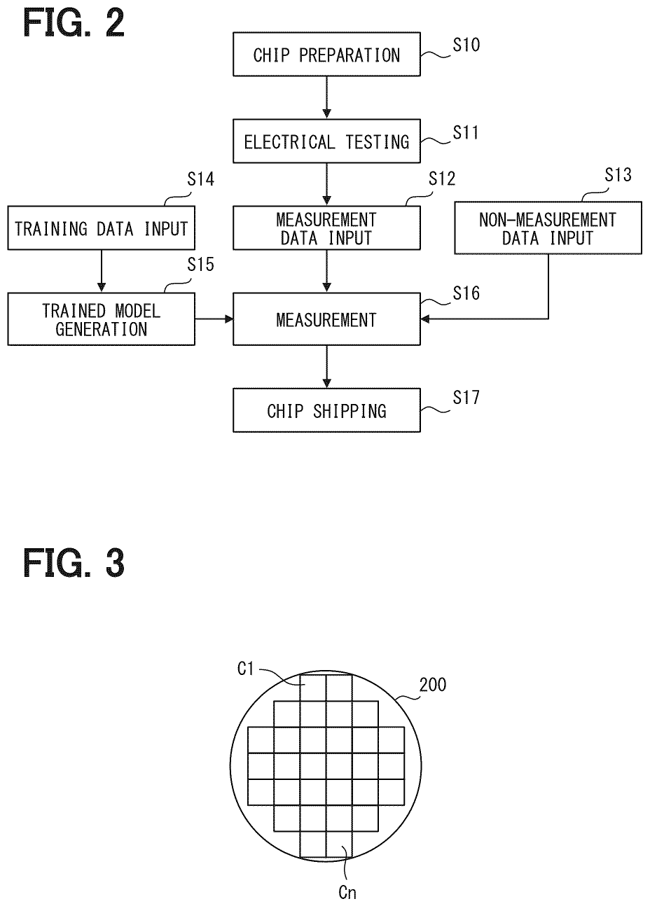

A prediction processing for the predicted data will be described with reference to FIG. 2. First, in a chip preparation process S10, the semiconductor wafer 200 on which the multiple semiconductor chips C1 to Cn are formed is prepared. That is, in the chip preparation process S10, the semiconductor wafer 200 to be predicted is prepared.

In an electrical testing process S11, the processor 21 of the measurement computer 20 instructs the measurement instrument 30 to perform a measurement. In response to the instruction from the processor 21, the measurement instrument 30 measures the electrical characteristics of each of the semiconductor chips C1 to Cn.

In a measurement data input process S12, the measurement instrument 30 inputs the measurement data, which includes the measured electrical characteristics as shown in FIG. 5, to the measurement computer 20. Thus, the measurement computer 20 acquires the measurement data for predicting the predicted data. The measurement data input process S12 can also be referred to as a measurement data acquisition process in which the measurement computer 20 acquires the measurement data.

In a non-measurement data input process S13, the non-measurement data as shown in FIG. 6 is input to the measurement computer 20. Thus, the measurement computer 20 acquires the non-measurement data for predicting the predicted data. The non-measurement data input process S13 can also be referred to as a non-measurement data acquisition process in which the measurement computer 20 acquires the non-measurement data.

In a training data input process S14, the training data as shown in FIG. 7 is input to the prediction computer 10. Thus, the prediction computer 10 acquires the training data for generating the prediction model. The training data input process S14 can also be referred to as a training data acquisition process in which the prediction computer 10 acquires the training data.

In a trained model generation process S15, the prediction computer 10 generates a prediction model, as the trained model, by using the training data as shown in FIG. 7. The prediction computer 10 generates the prediction model by machine learning from the measurement data, which are the measurement results at the time of a small current, and the non-measurement data, as the acquired training data, and the electrical characteristics in a high temperature environment or at the time of a large current.

In a prediction process S16, the prediction computer 10 predicts the predicted data. The prediction computer 10 predicts the predicted data by using the prediction model from the measurement data input in the process S12 and the non-measurement data input in the process S13. As a result, the prediction computer 10 obtains the predicted data as shown in FIG. 8. In this manner, the prediction computer 10 can obtain the electrical characteristics of each of the semiconductor chips C1 to C2, which are difficult to measure by the measurement instrument 30.

In the prediction process S16, the prediction computer 10 preferably uses two or more pieces of measurement data. This enables the prediction computer 10 to improve prediction accuracy, leading to the reduction in tolerances and the reduction in the costs for testing.

In a chip shipping process S17, the semiconductor chips C1 to C2 for which the measurement of the prediction data has been completed are shipped. In the chip shipping process S17, among the semiconductor chips C1 to C2, only the semiconductor chip the predicted data of which has met a reference value may be shipped.

The means and/or functions provided by the computer 10 or 20 can be provided by software recorded in the tangible memory device 12 or 22 and a computer that executes the software, software alone, hardware alone, or a combination of these. For example, when the computer 10 or 20 is implemented by an electronic circuit that is hardware, the electronic circuit can be implemented by a digital circuit including a large number of logic circuits, or an analog circuit.

### Effects

The characteristic prediction system 100 disclosed herein includes the memory device 12 in which the prediction model for predicting the predicted data is stored. The characteristic prediction system 100 predicts the predicted data, using the prediction model for predicting the predicted data, from at least the electrical characteristics (measurement data) acquired by the measurement instrument 30. Therefore, the characteristic prediction system 100 can predict the predicted data (i.e., the electrical characteristics) that are difficult to measure by the measurement instrument 30.

In particular, the semiconductor chips C1 to Cn, which are made of SiC as main component, are required to have a resistance at the temperature over 200° C. and the large current over 1000 A. Such semiconductor chips C1 to Cn are required to have the specifications guaranteed through the electrical testing. Further, in mass production of the semiconductor chips C1 to Cn, an expensive measurement instrument is necessary to perform measurement in the high temperature environment or at the large current, leading to the increase in the measurement costs or making it difficult to perform the measurement. In contrast, the characteristic prediction system 100 can predict the electrical characteristics of each of the semiconductor chips C1 to Cn that are beyond the measurable range of the measurement instrument 30 by using the prediction model. Therefore, the characteristic prediction system 100 enables to guarantee the specifications while suppressing the increase in the measurement costs.

Furthermore, it is conceivable to predict the electrical characteristics that are beyond the measurable range of the measurement instrument 30 by using a function. However, for the semiconductor chips C1 to Cn, it is necessary to take into consideration the degradation of prediction accuracy due to variations in epitaxial concentration and film thickness and process variations as tolerances. Further, the function is likely to be nonlinear, making it difficult to achieve high accuracy. In such a case, the tolerances must be factored into the chip performance, resulting in the increase in the costs of the chips. In contrast, the characteristic prediction system 100 predicts the predicted data by using the prediction model. Therefore, it is possible to perform the prediction with high accuracy. As such, it is possible to reduce the tolerances and the measurement costs.

Incidentally, the variations in concentration and film thickness of the drift layer tend to be concentric, making position information useful. In addition, the concentration and film thickness of the drift layer strongly affect direct current (DC) characteristics and alternating current (AC) characteristics. Therefore, it is preferable that the characteristic prediction system 100 uses the concentration and film thickness of the drift layer as the non-measurement data. In other words, the characteristic prediction system 100 can improve prediction accuracy by incorporating into the machine learning the concentration and film thickness of the drift layer as the non-measurement data. It can be said that the characteristic prediction system 100 can generate a prediction model that enables accurate prediction by incorporating into the machine learning the concentration and film thickness of the drift layer as the non-measurement data. Furthermore, the component information as non-measurement data may include information indicating a defect state of the semiconductor wafer 200 or information indicating the concentration and film thickness of a buffer layer.

The dimensions of the components such as the dimensions of the voltage sustaining layer, the dimensions of a trench in a trench MOS, and the film thickness of the gate insulating film largely affect the DC and AC characteristics. Therefore, the characteristic prediction system 100 can improve prediction accuracy by incorporating the dimensions of the components into machine learning as extra-measurement data. It can also be said that the characteristic prediction system 100 can generate the prediction model that enables accurate predictions by incorporating the dimensions of the components into machine learning.

The measurement data, such as forward voltage, saturation current, capacitance, switching loss, voltage change amount, current change amount, recovery current, surge voltage, and total gate charge amount are nonlinear with respect to the current value or the voltage value. Furthermore, since the coefficients also depend on the concentration and thickness of the drift layer, and on process variations, it is difficult to obtain high prediction accuracy even if the function is uniquely determined. Therefore, the characteristic prediction system 100 can improve the prediction accuracy by incorporating the non-measurement data into the machine learning, in addition to the measurement data. It can be also said that the characteristic prediction system 100 can generate the prediction model that enables accurate predictions by incorporating the non-measurement data into the machine learning in addition to the measurement data.

In regard to the tolerances such as short circuit tolerance, voltage change tolerance, recovery tolerance, and avalanche tolerance, it is difficult to perform measurement (electrically testing) on the semiconductor chips C1 to Cn under a load equivalent to that of actual operation due to ringing caused by the parasitic inductance of the measurement instrument 30 and the measurement limits of the measurement instrument 30. Therefore, it may be considered to carry out sampling tests, tests after the fabrication of the module, or to incorporate tests under loads lower than those used in actual operation into the electrical tests. Furthermore, the number of parameters that determine the tolerance is large and complex. For this reason, it has been difficult to predict the resistance of the semiconductor chips C1 to Cn when the load equivalent to that in an actual operation is applied from the electrical test. In contrast, the characteristic prediction system 100 uses the machine learning that can handle a large number of parameters and construct a complex prediction model, and therefore can predict the tolerance when a desired load is applied.

The embodiment of the present disclosure has been described hereinabove. However, the present disclosure is not limited to the embodiment described hereinabove, and various modifications may be made without departing from the gist of the present disclosure. The present disclosure can be implemented by various combinations of components illustrated in the embodiment, without being limited to those illustrated in the embodiment.

### Modified Examples

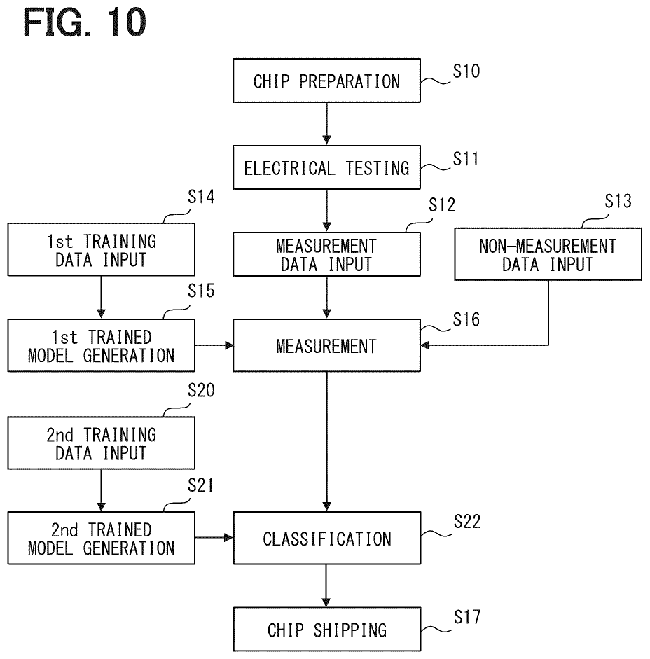

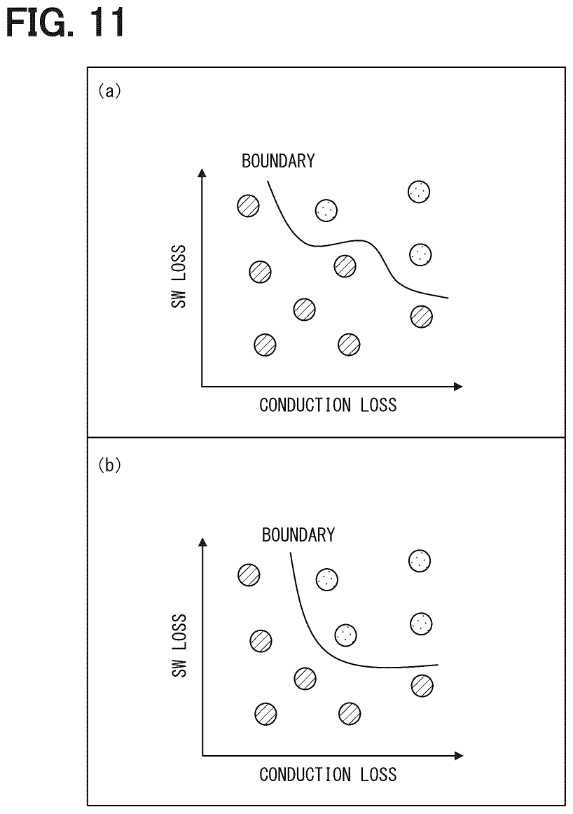

A modified example of the characteristic prediction system 100 will be described with reference to FIGS. 10 and 11. The characteristic prediction system 100 may perform a classification process in addition to the processes in the embodiment described above. In FIG. 10, the process that is similar to the process described in the embodiment described above is denoted by the same reference number. The processes S14 and S15 in FIG. 10 are similar to the processes S14 and S15 in FIG. 2. However, the names of the processes S14 and S15 are changed to distinguish from the processes S20 and S21.

The characteristic prediction system 100 performs a second training data input process S20, a second trained model generation process S21, and a classification process S22 between the prediction process S16 and the chip shipping process S17. However, the processes S20 and S21 may be performed before the process S16 is completed.

In the second training data input process S20, the second training data is input to the prediction computer 10. The second training data is training data for generating the second trained model. In other words, the second training data is different from the training data for generating the prediction model. The prediction computer 10 acquires second training data for generating a classification model, which is the second trained model. The second training data input process S20 can also be considered as a second training data acquisition process in which the prediction computer 10 acquires the second training data.

In the second trained model generation process S21, the prediction computer 10 generates the classification model. The second trained model is a machine learning model for performing classification, differently from the prediction model. The prediction computer 10 generates the classification model by machine learning using the second training data.

The classification model may include, for example, a logistic regression or a linear support vector machine as a linear classifier. Examples of the non-linear classifier may include k-nearest neighbors, decision trees, random forests, non-linear support vector machines, and deep learning. If the data set is imbalanced, over-sampling or under-sampling may be performed.

In the classification process S22, the prediction computer 10 classifies the semiconductor chips C1 to Cn. The prediction computer 10 classifies (sorts, identifies) the semiconductor chips C1 to Cn using the classification model and at least one of the prediction data acquired in the process S16. That is, the prediction computer 10 determines the boundary and classifies the semiconductor chips C1 to Cn according to the prediction data.

FIG. 11 shows an example in which the semiconductor chips C1 to Cn are classified based on power loss, which is the combination of conduction loss and switching loss and includes one or more data pieces of on-resistance, turn-on loss, turn-off loss, and recovery loss predicted by the prediction model. The characteristic prediction system 100 classifies the semiconductor chips C1 to Cn into a class A indicated with diagonal hatching, and a class B indicated with dot hatching, with a boundary line as the boundary. As shown in (a) and (b) of FIG. 11, the classification in the classification process S22 can be changed depending on purposes. In other words, the boundary line can be changed depending on the purposes.

In this manner, the prediction computer 10 obtains classification data in which the semiconductor chips C1 to Cn are classified, as shown in FIG. 11. That is, the characteristic prediction system 100 predicts out-of-range characteristics of the multiple semiconductor chips C1 to Cn and classifies the multiple semiconductor chips C1 to Cn based on the prediction data of each of the semiconductor chips C1 to Cn. In the characteristic prediction system 100, the tolerance of each item can be reduced by performing the classification process S22, and thus the improvements of the inverter performance and chip yield are expected.

For example, in an inverter circuit or the like, a configuration in which semiconductor chips are driven in parallel is conceivable. Such an inverter circuit may have a configuration including a plurality of semiconductor modules, each of which has a plurality of semiconductor chips connected in parallel. In this case, the characteristic prediction system 100 may classify the semiconductor chips C1 to Cn using the threshold voltage at a high temperature predicted by the prediction model. This allows a plurality of semiconductor chips classified into the same class to be used in one module and one inverter circuit. Therefore, the characteristic prediction system 100 can suppress unbalanced operation of semiconductor chips within a module or between modules.

Although the present disclosure has been described in accordance with the embodiments, it is understood that the present disclosure is not limited to the embodiments and the structures. The present disclosure encompasses various modifications and variations within the scope of equivalents. In addition, while various combinations and modes are described in the present disclosure, other combinations and modes including only one element, more elements, or less elements therein are also within the scope and spirit of the present disclosure.

What is claimed is:

1. A characteristic prediction system comprising:
a measurement device configured to acquire an electrical characteristic of a semiconductor device measured by a measurement instrument;
a memory unit in which a prediction model for predicting an out-of-range characteristic, which is the electrical characteristic beyond a measurable range of the measurement instrument, is stored; and
a prediction device configured to predict the out-of-range characteristic from at least the electrical characteristic acquired by the measurement device using the prediction model, wherein
the prediction device is configured to generate the prediction model by machine learning using training data.

2. The characteristic prediction system according to claim 1, wherein
the prediction device is configured to predict the out-of-range characteristic from the electrical characteristic and non-electrical information about the semiconductor device different from the electrical characteristic, using the prediction model.

3. The characteristic prediction system according to claim 2, wherein
the semiconductor device is one of a plurality of chips formed on a semiconductor wafer, and
the non-electrical information includes at least one of coordinate information of each chip on the semiconductor wafer, component information of each chip on the semiconductor wafer, or manufacturing process information of the semiconductor device.

4. The characteristic prediction system according to claim 3, wherein
the component information includes information on a concentration of a drift layer and a film thickness of the drift layer.

5. The characteristics prediction system according to claim 3, wherein
the manufacturing process information includes information indicating dimensions of at least one component of the semiconductor device measured in a manufacturing process.

6. The characteristic prediction system according to claim 1, wherein
the electrical characteristic acquired by the measurement device include at least one of an on-voltage, a threshold voltage, a breakdown voltage, a forward voltage, a saturation current, a capacitance, a switching loss, a voltage change rate, a current change rate, a recovery current, a surge voltage, or a gate total charge.

7. The characteristic prediction system according to claim 1, wherein
the electrical characteristic acquired by the measurement device includes at least one of a short circuit resistance, a voltage change resistance, a recovery resistance, or an avalanche resistance.

8. The characteristic prediction system according to claim 1, wherein
the semiconductor device is one of a plurality of chips formed on a semiconductor wafer, and
the prediction device is configured to predict the out-of-range characteristic of the plurality of chips and classifies the plurality of chips based on the out-of-range characteristics of the respective chips.

9. A characteristic prediction system comprising:
a measurement device configured to acquire an electrical characteristic of a semiconductor device measured by a measurement instrument;
a memory unit in which a prediction model for predicting an out-of-range characteristic, which is the electrical characteristic beyond a measurable range of the measurement instrument, is stored; and
a prediction device configured to predict the out-of-range characteristic from at least the electrical characteristic acquired by the measurement device using the prediction model, wherein
the prediction device is configured to predict the out-of-range characteristic from the electrical characteristic and non-electrical information about the semiconductor device different from the electrical characteristic, using the prediction model,
the semiconductor device is one of a plurality of chips formed on a semiconductor wafer, and
the non-electrical information includes at least one of coordinate information of each chip on the semiconductor wafer, component information of each chip on the semiconductor wafer, or manufacturing process information of the semiconductor device, and
the component information includes information on a concentration of a drift layer and a film thickness of the drift layer.

10. The characteristic prediction system according to claim 1, wherein
the measurement device and the prediction device are each provided by a processor.

11. The characteristic prediction system according to claim 9, wherein
the measurement device and the prediction device are each provided by a processor.
